(19) United States
(12) Patent Application Publication
(10) Pub. No.: US 2020/0092484 A1
(43) Pub. Date: Mar. 19, 2020

(54) IMAGE DISPLAY CONTROL APPARATUS, IMAGE DISPLAY CONTROL METHOD, PROGRAM, AND RECORDING MEDIUM

(71) Applicant: FUJIFILM Corporation, Tokyo (JP)

(72) Inventor: Naoya ITO, Tokyo (JP)

(73) Assignee: FUJIFILM Corporation, Tokyo (JP)

(21) Appl. No.: 16/521,684

(22) Filed: Jul. 25, 2019

(30) Foreign Application Priority Data
Sep. 18, 2018 (JP) 2018-173734

(51) Int. Cl. H04N 5/232; H04N 1/00

(52) U.S. Cl. CPC H04N 5/23293; H04N 1/00204; H04N 1/00161

(57) ABSTRACT

Provided are an image display control apparatus, an image display control method, a program, and a recording medium capable of simply confirming a share range of an image possessed by a user. In the image display control apparatus, the image display control method, the program, and the recording medium an image reception unit receives an input of an image group possessed by a first user in accordance with a command for designating the image group, a share attribute reading unit reads share attribute information that represents share ranges of respective images, assigned to the respective images included in the image group, from the respective images, and an image display controller classifies the images included in the image group for each share range type, on the basis of the share attribute information read from the respective images, and displays the classified images on a display.

### CROSS-REFERENCE TO RELATED APPLICATIONS

The present application claims priority under 35 U.S.C. § 119 to Japanese Patent Application No. 2018-173734, filed on Sep. 18, 2018. Each of the above application(s) is hereby expressly incorporated by reference, in its entirety, into the present application.

### BACKGROUND OF THE INVENTION

### 1. Field of the Invention

The present invention relates to an image display control apparatus, an image display control method, a program, and a recording medium for classifying and displaying images included in an image group possessed by a user for each type of an image share range.

### 2. Description of the Related Art

A technique for releasing, using a social network service (SNS), images possessed by a user to unspecified users who use the SNS, or sharing the images only with shared users.

For example, in a case where a user sets a share range to be released and posts an image, the image is released to unspecified users who use the SNS, and a mark indicating that the share range is in a public state is displayed. Further, in a case where the user sets the share range to be shared and posts an image, the image is shared only with shared users registered as friends of the user, and a mark indicating that the share range is a share state is displayed.

Here, as prior arts relevant to the invention, there are JP4900847B and JP2004-259071A.

JP4900847B discloses a content data management apparatus that determines whether a user of a user terminal that transmits an access request with respect to content data is able to access the content data, on the basis of content information including a group ID capable of accessing the content data and group registration information including a group ID to which the user belongs, and transmits the content data to the user terminal in a case where it is determined that the user is able to access the content data.

JP2004-259071A discloses a home server that sets an individually providable level with respect to content information, stores the content information and the providable level in association, determines content that is providable to an access source terminal device with respect to a homepage on the basis of the providable level, and provides homepage information in which the content that is determined to be providable is incorporated in a terminal device.

### SUMMARY OF THE INVENTION

As described above, a mark indicating its share range is displayed for each image, but in a case where publishing and sharing of images are repeated, it is difficult to know which image is published and which image is shared with shared users. Further, a beginner who just starts using the SNS may mistakenly set a share range to post an image, or may unintentionally publish or share the image. Accordingly, there is a problem in that it is difficult for users to use the SNS safely.

Accordingly, an object of the invention is to provide an image display control apparatus, an image display control method, a program, and a recording medium capable of simply checking a share range of an image possessed by a user.

According to an aspect of the invention, there is provided an image display control apparatus comprising: an image reception unit that receives an input of an image group possessed by a first user in accordance with a command for designating the image group; a share attribute reading unit that reads share attribute information that represents share ranges of respective images, assigned to the respective images included in the image group, from the respective images; and an image display controller that classifies the images included in the image group for each share range type, on the basis of the share attribute information read from the respective images, and displays the classified images on a display.

Here, it is preferable that the share range type includes a public state where an image is released to an unspecified user, a share state where the image is shared only with a share user, and a private state where the image is not released to any user, and the image display controller classifies and displays the images included in the image group into a public image in the public state, a share image in the share state, and a private image in the private state.

It is preferable that in a case where there are two or more sets of share images that are respectively shared with two or more share users, the image display controller classifies the two or more sets of share images for each set and displays the classified share images.

It is preferable that the share range type includes a public state where an image is released to an unspecified user, a share state where the image is shared only with a share user, and a private state where the image is not released to any user, and the image display controller displays a first button for displaying a public image in the public state, a second button for displaying a share image in the share state, and a third button for displaying a private image in the private state, and the image display controller displays the public image in a case where the first button is selected, displays the share image in a case where the second button is selected, and displays the private image in a case where the third button is selected.

It is preferable that in a case where there are two or more sets of share images that are respectively shared with two or more share users, the image display controller displays two or more second buttons for respectively displaying the two or more sets of share images.

It is preferable that the share range type includes a public state where an image is released to an unspecified user, a share state where the image is shared only with a share user, and a private state where the image is not released to any user, and the image display controller respectively disposes public images in the public state, share images in the share state, and private images in the private state side by side at least in a horizontal direction, displays only a predetermined number of images corresponding to a lateral width of a display area of the display, and displays remaining images that are not displayed in a case where the displayed images are scrolled in the horizontal direction.

It is preferable that in a case where there are two or more sets of share images that are respectively shared with two or more share users, the image display controller classifies the two or more sets of share images for each set, and disposes the classified share images side by side in a vertical direction for display.

It is preferable that the image display controller displays information indicating that the public image is in the public state, the share image is in the share state, and the private image is in the private state.

It is preferable that the image display controller displays the share image and a name of the share user who shares the share image in association.

It is preferable that the image display control apparatus further comprises: an image narrowing unit that narrows down the images included in the image group to images that satisfy a narrowing condition in accordance with a command for setting an image narrowing condition, and the image display controller displays only the images narrowed by the image narrowing unit, from among the images included in the image group.

It is preferable that the image narrowing unit narrows down the images included in the image group to images to which at least one of tag information or Exif information set as the narrowing condition is assigned, on the basis of at least one of the tag information or the Exif information assigned to each image.

It is preferable that the image display control apparatus further comprises: an image analyzer that analyzes the respective images, and a score calculator that calculates scores of the respective images on the basis of analysis results of the respective images, and the image narrowing unit narrows down the images included in the image group to images having scores that are equal to or greater than a threshold set as the narrowing condition, on the basis of the scores of the respective images calculated by the score calculator.

It is preferable that the image display control apparatus further comprises: an image selector that selects one image or two or more images from the images included in the image group in accordance with a command for selecting an image; a share range setting unit that sets share ranges of the one image or two or more images selected by the image selector in accordance with a command for setting the image share range; and an image sharing unit that sets, in a case where the share range is set to the public state, the share state, or the private state by the share range setting unit, the one image or two or more images selected by the image selector to the public state, to the share state, or to the private state, in accordance with a command for setting an image to the public state, the share state, or the private state; and a share attribute assigning unit that assigns the share attribute information indicating the public state, the share state, or the private state to the one image or two or more images that are in the public state, the share state, or the private state.

It is preferable that the image display control apparatus further comprises: a share user setting unit that sets a share user who shares the one image or two or more images selected by the image selector in accordance with a command for setting the share user in a case where the share range is set to the share state by the share range setting unit, the image sharing unit shares the one image or two or more images selected by the image selector only with the share user set by the share user setting unit in accordance with a command for setting the image to the share state, and the share attribute assigning unit assigns the share attribute information indicating the share state to the share user set by the share user setting unit to each of the shared one image or two or more images.

It is preferable that one set of share images are shared with two or more share users.

It is preferable that the share user is at least one of a second user or a group of two or more users.

It is preferable that the image display controller displays a menu item button for classifying and displaying the images included in the image group for each share range type on a menu list screen at the highest level.

According to another aspect of the invention, there is provided an image display control method comprising: a step of receiving an input of an image group possessed by a first user in accordance with a command for designating the image group, using an image reception unit; a step of reading share attribute information that represents share ranges of respective images, assigned to the respective images included in the image group, from the respective images, using a share attribute reading unit; and a step of classifying the images included in the image group for each share range type, on the basis of the share attribute information read from the respective images, and displays the classified images on a display, using an image display controller.

Here, it is preferable that the share range type includes a public state where an image is released to an unspecified user, a share state where the image is shared only with a share user, and a private state where the image is not released to any user, and the images included in the image group are classified into a public image in the public state, a share image in the share state, and a private image in the private state, and the classified images are displayed.

It is preferable that the share range type includes a public state where an image is released to an unspecified user, a share state where the image is shared only with a share user, and a private state where the image is not released to any user, and a first button for displaying a public image in the public state, a second button for displaying a share image in the share state, and a third button for displaying a private image in the private state are displayed, and the public image is displayed in a case where the first button is selected, the share image is displayed in a case where the second button is selected, and the private image is displayed in a case where the third button is selected.

It is preferable that the share range type includes a public state where an image is released to an unspecified user, a share state where the image is shared only with a share user, and a private state where the image is not released to any user, and public images in the public state, share images in the share state, and private images in the private state are respectively disposed side by side at least in a horizontal direction, only a predetermined number of images corresponding to a lateral width of a display area of the display is displayed, and remaining images that are not displayed are displayed in a case where the displayed images are scrolled in the horizontal direction.

It is preferable that the image display control method further comprises: a step of narrowing down the images included in the image group to images that satisfy a narrowing condition in accordance with a command for setting an image narrowing condition, using an image narrowing unit, and only the narrowed images from among the images included in the image group are displayed.

It is preferable that the image display control method further comprises: a step of selecting one image or two or more images from the images included in the image group, in accordance with a command for selecting an image, using an image selector; a step of setting share ranges of the one image or two or more images selected by the image selector, in accordance with a command for setting the image share range, using a share range setting unit; and a step of setting, in a case where the share range is set to the public state, the share state, or the private state by the share range setting unit, the one image or two or more images selected by the image selector to the public state, to the share state, or to the private state, in accordance with a command for setting an image to the public state, the share state, or the private state, using an image sharing unit; and a step of assigning the share attribute information indicating the public state, the share state, or the private state to the one image or two or more images that are in the public state, the share state, or the private state, using a share attribute assigning unit.

According to still another aspect of the invention, there is provided a program for causing a computer to execute the respective steps of the image display control method described above.

According to still another aspect of the invention, there is provided a computer-readable recording medium on which a program for causing a computer to execute the respective steps of the image display control method described above.

According to still another aspect of the invention, there is provided an image display control apparatus comprising: an image reception unit that receives an input of an image group possessed by a first user in accordance with a command for designating the image group; a share attribute reading unit that reads share attribute information that represents share ranges of respective images, assigned to the respective images included in the image group, from the respective images; and an image display controller that classifies the images included in the image group for each share range type, on the basis of the share attribute information read from the respective images, and displays the classified images on a display, and the image reception unit, the share attribute reading unit, and the image display controller are configured by a processor that executes dedicated hardware or a program.

It is preferable that the image display control apparatus further comprises: an image narrowing unit that narrows down the images included in the image group to images that satisfy a narrowing condition in accordance with a command for setting an image narrowing condition, and the image display controller displays only the images narrowed by the image narrowing unit, from among the images included in the image group, in which the image narrowing unit is configured by the processor that executes the dedicated hardware or the program.

It is preferable that the image display control apparatus further comprises: an image analyzer that analyzes the respective images; and a score calculator that calculates scores of the respective images on the basis of analysis results of the respective images, and the image narrowing unit narrows down the images included in the image group to images having scores that are equal to or greater than a threshold set as the narrowing condition, on the basis of the scores of the respective images calculated by the score calculator, in which the image analyzer and the score calculator are configured by the processor that executes the dedicated hardware or the program.

It is preferable that the image display control apparatus further comprises: an image selector that selects one image or two or more images from the images included in the image group in accordance with a command for selecting an image; a share range setting unit that sets share ranges of the one image or two or more images selected by the image selector in accordance with a command for setting the image share range; and an image sharing unit that sets, in a case where the share range is set to the public state, the share state, or the private state by the share range setting unit, the one image or two or more images selected by the image selector to the public state, to the share state, or the private state, in accordance with a command for setting an image to the public state, the share state, or the private state; and a share attribute assigning unit that assigns the share attribute information indicating the public state, the share state, or the private state to the one image or two or more images that are in the public state, the share state, or the private state, in which the image selector, the share range setting unit, the image sharing unit, and the share attribute assigning unit are configured by the processor that executes the dedicated hardware or the program.

It is preferable that the image display control apparatus further comprises: a share user setting unit that sets a share user who shares the one image or two or more images selected by the image selector in accordance with a command for setting the share user in a case where the share range is set to the share state by the share range setting unit, the image sharing unit shares the one image or two or more images selected by the image selector only with the share user set by the share user setting unit in accordance with a command for setting the image to the share stated, and the share attribute assigning unit assigns the share attribute information indicating the share state to the share user set by the share user setting unit to each of the shared one image or two or more images, in which the share user setting unit is configured by the processor that executes the dedicated hardware or the program.

According to the invention, it is possible to classify the images included in the image group for each share range type and display the classified images on the display. Thus, it is possible to simply confirm which image is released, which image is shared, or which image is non-released, and it is possible to safely publish or share an image using the image processing system.

### BRIEF DESCRIPTION OF THE DRAWINGS

FIG. 1 is a block diagram showing a configuration of an image processing system according to an embodiment of the invention.

FIG. 2 is a block diagram showing a configuration of a client according to the embodiment.

FIG. 3 is a flowchart showing an operation of the image processing system according to the embodiment.

FIG. 4 is a flowchart showing an operation of the image processing system in narrowing down images is performed, according to the embodiment.

FIG. 5 is a flowchart showing an operation of the image processing system in a case where a setting for releasing, sharing, or non-releasing an image is performed, according to the embodiment.

FIG. 6 is a flowchart showing an operation of the image processing system in a case where images included in an image group are classified and displayed for each share range type, according to the embodiment.

FIG. 7 is a conceptual diagram showing a top level image displayed by a program operated on a smartphone, according to the embodiment.

FIG. 8 is a conceptual diagram showing a screen of a menu list of a top level, according to the embodiment.

FIG. 9 is a conceptual diagram showing a list display screen of a photo/motion picture, according to the embodiment.

FIG. 10 is a conceptual diagram showing a list display screen of an album, according to the embodiment.

FIG. 11 is a conceptual diagram showing a list display screen of images included in an album, according to the embodiment.

FIG. 12 is a conceptual diagram showing a list display screen of photos/motion pictures that are narrowed down to good images, according to the embodiment.

FIG. 13 is a conceptual diagram showing an image selection screen, according to the embodiment.

FIG. 14 is a conceptual diagram showing a share setting image, according to the embodiment.

FIG. 15 is a conceptual diagram showing a share status list screen, according to the embodiment.

### DESCRIPTION OF THE PREFERRED EMBODIMENTS

Hereinafter, an image display control apparatus, an image display control method, a program, and a recording medium according to embodiments of the invention will be described on the basis of preferred embodiments shown in the accompanying drawings.

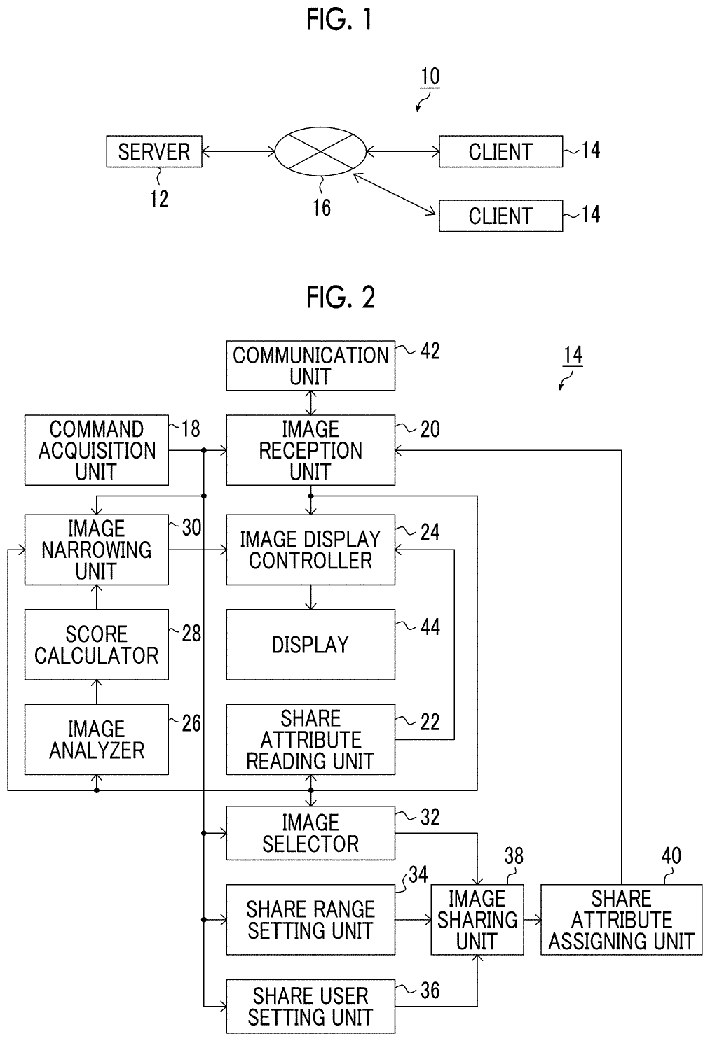

FIG. 1 is a block diagram showing a configuration of the image processing system according to an embodiment of the invention. An image processing system 10 shown in FIG. 1 includes a server 12, and a plurality of clients 14 that are respectively connected to a server 12 through a network 16.

The server 12 has a function for acquiring image groups possessed by a plurality of users who use the image processing system 10, and publishing respective images included in the image group possessed by each of the plurality of users to unspecified users, sharing the images only with shared users, or setting the images to be non-released, for example. The server 12 is not limited to a single server, and may be a plurality of servers. Further, the server 12 may be configured by a workstation or the like having a control device, a storage device, a communication device, and the like.

The client 14 is an image display control apparatus according to this embodiment, and has a function for classifying and displaying images possessed by each user for each share range type of images (which will be described later), for example. The client 14 is configured by a desktop PC (personal computer), a laptop PC, a tablet PC, or a mobile terminal such as a mobile phone or a smartphone, or the like.

FIG. 2 is a block diagram showing a configuration of a client according to the embodiment. The client 14 shown in FIG. 2 includes a command acquisition unit 18, an image reception unit 20, a share attribute reading unit 22, an image display controller 24, an image analyzer 26, a score calculator 28, an image narrowing unit 30, an image selector 32, a share range setting unit 34, a share user setting unit 36, an image sharing unit 38, a share attribute assigning unit 40, a communication unit 42, and a display 44.

Hereinafter, the client 14 possessed by a first user will be described. The first user is an unspecified user among all users who use the image processing system 10. In this embodiment, the client 14 of the first user will be described, but the client 14 possessed by users other than the first user have the same configuration and function.

In the client 14 of the first user, first, the command acquisition unit 18 acquires various commands input from the first user using an input device such as a keyboard, a mouse, or a touch panel.

The first user inputs the commands using the input device while viewing a screen displayed on the display 44. The commands input by the first user are not particularly limited, but include a command for designating an image group, a command for displaying images included in the image group, a command for setting an image narrowing condition, a command for selecting an image, a command for setting an image share range, a command for setting an image share user, a command for setting an image to a public state, a share state, or a private state, or the like.

Subsequently, the image reception unit 20 receives an input of the image group possessed by the first user in accordance with the command for designating the image group. In other words, the image reception unit 20 acquires the image group possessed by the first user.

The image group possessed by the first is not particularly limited, but includes an image group stored in a storage device of the client 14 of the first user, an image group recorded on an external recording medium such as a universal serial bus (USB) memory, a secure digital (SD) memory, a compact disc (CD), a digital versatile disc (DVD), or a hard disk (HD), an image group stored in an online storage, an image group posted to an SNS, or the like. Further, the image also includes a motion picture as well as a still image.

Accessory information such as attribute information, tag information, and share attribute information may be assigned to the respective images included in the image group.

The attribute information is information for representing an attribute of an image, and for example, may include Exchangeable image file format (Exif) information. The Exif information is information relating to an image capturing condition, and for example, includes information on imaging date and time of an image, an imaging location (position information), a focal distance, exposure, or the like. The Exif information is assigned as header information of an image (image data) captured by a digital camera or the like.

The tag information is a title that represents attribute information of an image, a subject taken in the image (a person and an object other than the person), or a scene, an event, an impression, or the like read out from the image. For example, in a case where an imaging year of an image is 2018, tag information of “2018” is assigned to the image, and in a case where an imaging location of the image is Tokyo, tag information of “Tokyo” is assigned to the image. Further, in a case where “meat” and a plurality of “persons” are taken in the image as subjects, tag information of “meat”, “person”, “drinking party”, “women's association”, and the like is assigned to the image. In a case where “person” taken in the image has a smiling face, tag information of “smiling face”, “happy”, or the like is assigned to the image. The tag information is automatically assigned to the image on the basis of an analysis result of the image, or the first user may manually assign the tag information to the image.

The share attribute information is information assigned to an image by the share attribute assigning unit 40, which represents an image sharing range. Types of image share ranges include, for example, a public state where an image is released to unspecified users, a share state where an image is shared only with shared users, and a private state where an image is not released to anyone.

Subsequently, the share attribute reading unit 22 reads out share attribute information indicating sharing ranges of respective images, which is assigned to the respective images included in the image group possessed by the first user, from the respective images.

Then, the image display controller 24 basically groups the images included in the image group possessed by the first user in accordance with commands for displaying the images in the unit of an imaging date, and displays the result on the display 44 in a time-series manner. Further, the image display controller 24 may classify the images included in the image group possessed by the first user for each sharing range type, on the basis of the share attribute information read out from the respective images, and may display the result on the display 44. In the case of this embodiment, the image display controller 24 may classify the images included in the image group into public images in the public state, share images in the share state, and private images in the private state, and may display the result on the display 44.

Then, the image analyzer 26 analyzes the respective images included in the image group possessed by the first user.

The image analysis is not particularly limited, but includes brightness determination, color evaluation, blur evaluation, attribute information analysis, subject recognition for recognizing a subject taken in an image, scene recognition (night view, sea, sandy beach, sky, or the like), event detection (sports day, wedding ceremony, graduation ceremony, or the like), and the like. The subject recognition includes face detection, person detection (face recognition), object recognition (meat, fruits, flowers, cake, or the like), and the like.

Subsequently, the score calculator 28 calculates scores of the respective images on the basis of analysis results of the respective images.

A method for calculating the scores of the images is not particularly limited, but for example, as a result of brightness determination, a brightness score in a case where an image brightness is appropriate is set to 1.0, and a brightness score in a case where the image brightness is too bright or too dark is set to be lower. Further, as a result of color evaluation, a color score in a case where a color hue of an image is vivid is set to be relatively high, and a color score in a case where a hue of an image is dark or colorless is set to be relatively low. As a result of blur evaluation, a blur score in a case where blur is not present is set to 1.0, and the blur score is set to be lower in accordance with the degree of blur. The score calculator 28 adds up, for example, the brightness score, the color score, the blur score, and the like to calculate a total value, to thereby calculate a score of an image.

Subsequently, the image narrowing unit 30 narrows down the images included in the image group to images that satisfy a narrowing condition, in accordance with the command for setting the image narrowing condition. The narrowing condition includes tag information, Exif information, an image score, and the like.

Then, the image selector 32 selects one image or two or more images from the images included in the image group possessed by the first user, in accordance with the command for selecting the image.

Subsequently, the share range setting unit 34 sets share ranges of the one image or two or more images selected by the image selector 32, in accordance with the command for setting the image share range.

In the case of this embodiment, a share range of an image is set to the public state in accordance with the command for setting the image to the public state. Further, the share range of the image is set to the share state in accordance with the command for setting the image to the share state. The share range of the image is set to the private state in accordance with the command for setting the image to the private state.

Subsequently, in a case where the share range of the image is set to the share state by the share range setting unit 34, the share user setting unit 36 sets a share user who shares the one image or two or more images selected by the image selector 32, in accordance with a command for setting the image share user.

The share user is at least one of a second user or a group of two or more users, among the plurality of users who use the image processing system 10. The second user corresponds to one or more users different from the first user. The group is a group of two or more users who are set in advance by a certain user, before share users are set. The group may include the first user, or may not include the first user.

Subsequently, in a case where the share range of the image is set to the public state and the private state by the share range setting unit 34, the image sharing unit 38 sets the one image or two or more images selected by the image selector 32 to the public state or the private state with respect to unspecified users. Further, in a case where the share range of the image is set to the share state by the share range setting unit 34, the one image or two or more images selected by the image selector 32 are shared only with the share users who are set by the share user setting unit 36.

Then, in a case where the share range of the image is set to the public state and the private state by the share range setting unit 34, the share attribute assigning unit 40 assigns share attribute information indicating the public state and the private state to one image or two or more images that are released and non-released, respectively. Further, in a case where the share range of the image is set to the share state by the share range setting unit 34, the share attribute assigning unit 40 assigns share attribute information indicating the share state to the share users set by the share user setting unit 36, with respect to the shared one image or two or more images, respectively.

Subsequently, the communication unit 42 is a communication device that is possessed by the client 14, and performs transmission and reception of a variety of data with respect to a communication device possessed by the server 12.

The communication unit 42 uploads an image (image data) stored in the storage device of the client 14, for example, to the server 12 from the client 14 through the network 16, or downloads an image stored in the storage device of the server 12 to the client 14 from the server 12 through the network 16.

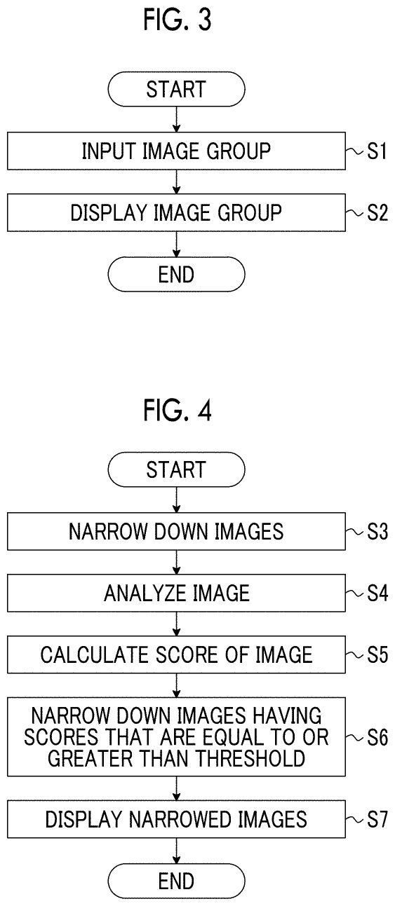

Next, an operation of the image processing system 10 will be described with reference to a flowchart shown in FIG. 3.

In the client 14 possessed by the first user, first, an input of the image group possessed by the first user is received in accordance with the command for designating the image group, by the image reception unit 20 (Si). The image group is stored in the storing device of the client 14. The image group is uploaded to the server 12 from the client 14 through the network 16, and is stored in the storage device of the server 12.

Subsequently, the images included in the image group are basically grouped in the unit of an imaging date, in accordance with the command for displaying the image, and are displayed on the display 44 in a time-series manner, by the image display controller 24 (S2).

Next, an operation in a case where the first user narrows down images will be described with reference to a flowchart shown in FIG. 4.

In this case, the images included in the image group are narrowed down to images that satisfy the narrowing condition, in accordance with the command for setting the image narrowing condition, by the image narrowing unit 30 (S3).

For example, in a case where the narrowing information is at least one of the tag information or the Exif information, the images included in the image group are narrowed down to images to which at least one of tag information or Exif information set as the narrowing condition, on the basis of at least one of the tag information or the Exif information assigned to respective images, by the image narrowing unit 30.

Further, in a case where the narrowing condition is an image score, the respective images are analyzed by the image analyzer 26 (S4). Subsequently, scores of the respective images are calculated on the basis of analysis results of the respective images, by the score calculator 28 (S5). Then, the images included in the image group are narrowed down to images having scores that are equal to or greater than a threshold set as a narrowing condition, on the basis of the scores of the respective images, by the image narrowing unit 30 (S6). Then, only the images narrowed by the image narrowing unit 30 among the images included in the image group are displayed on the display 44, by the image display controller 24 (S7).

In this way, in the image processing system 10, it is possible to narrow down the images included in the image group to images that satisfy the narrowing condition, and to display only the narrowed images on the display 44.

The analysis of the images and the calculation of the scores are performed in a certain period of time before the images are narrowed down after the image group is received. Further, as the narrowing condition, two or more of the tag information, the Exif information, the image score, and the like may be simultaneously used as the narrowing condition.

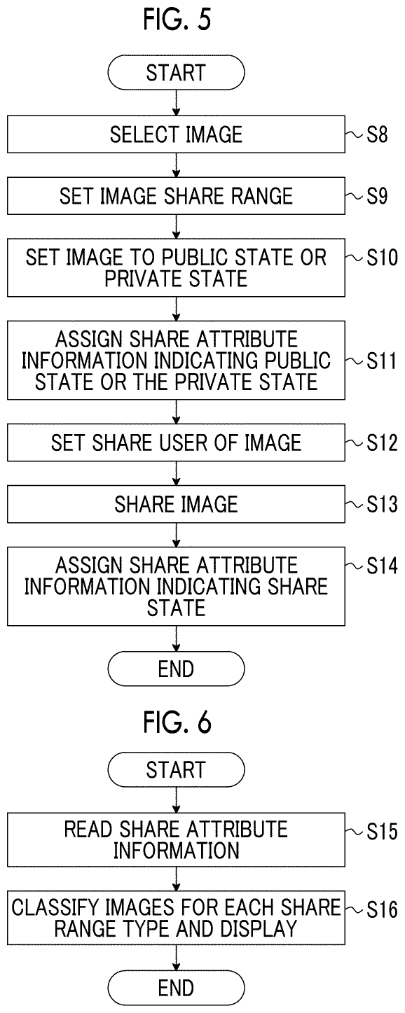

Next, an operation in a case where an image is set to be released, shared, or non-released will be described with reference to a flowchart shown in FIG. 5.

In this case, first, one image or two or more images are selected from the images included in the image group in accordance with the command for selecting the image, by the image selector 32 (S8). Then, an image share range is set in accordance with the command for setting the image share range, by the share range setting unit 34 (S9).

In a case where the image share range is set to the public state and the private state, the image selected by the image selector 32 is set to the public state or the private state, in accordance with the command for setting the image to the public state or the private state, by the image sharing unit 38 (S10). Subsequently, share attribute information indicating the public state and the private state is assigned to the one image or two or more images set to the public state and the private state, by the share attribute assigning unit 40 (S11).

In a case where the image share range is set to the share state, share users of the images are set in accordance with the command for setting the share users, by the share user setting unit 36 (S12). The images selected by the image selector 32, that is, a set of share images may be set to be shared with two or more share users. Subsequently, the images selected by the image selector 32 are shared only with the share users set by the share user setting unit 36, in accordance with the command for setting the image to the share state by the image sharing unit 38 (S13). Then, share attribute information indicating the share state with respect to the share users set by the share user setting unit 36 is assigned to each of the shared one image or two or more images by the share attribute assigning unit 40 (S14).

In this way, in the image processing system 10, it is possible to select an unspecified image from the image group to set the selected image to the public state, the share state, or the private state.

Next, an operation in a case where images included in an image group are classified and displayed for each share range type will be described with reference to a flowchart shown in FIG. 6.

In this case, first, share attribute information assigned to the respective images included in the image group is read from the respective images, by the share attribute reading unit 22 (S15).

Subsequently, the images included in the image group are classified and displayed on the display 44 for each share range type, on the basis of the share attribute information read from the respective images, by the image display controller 24 (S16). Further, the fact that the public image is in the public state, the share image is in the share state, and the private image is in the private state is displayed on the display 44. Further, the share image and names of the share users who share the share image are displayed on the display 44 in association.

Further, in a case where there are two or more sets of share images that are respectively shared with two or more share users, the two or more sets of share images are classified for each set and are displayed on the display 44. Further, the two or more sets of share images and respective names of two or more share users that share the two or more sets of share images are respectively displayed on the display 44 in association.

In this way, in the image processing system 10, it is possible to classify the images included in the image group for each share range type, and to display the images on the display 44. Thus, it is possible to simply check which image is set to be released, which image is set to be shared, and which image is set to be non-released, and thus, it is possible to release or share the images safely using the image processing system 10.

The reading of the share attribute information is performed in a certain period of time before the images included in the image group are classified for each share range type and are displayed on the display 44 after the image group is received.

Here, in a case where the number of images is large, respective display areas of public images, share images, and private images become large, and thus, there is a case where it is difficult to simultaneously display all of the public images, the share images, and the private images on the display 44.

On the other hand, for example, a configuration in which a first button for displaying the public images, a second button for displaying the share images, a third button for displaying the private images are displayed on the display 44, in a case where the first button is selected, the public images are displayed on the display 44, in a case where the second button is selected, the share images are displayed on the display 44, and in a case where the third button is selected, the private images are displayed on the display 44 may be employed.

Further, in a case where there are two or more sets of share images that are respectively shared with two or more share users, two or more second buttons for respectively displaying the two or more sets of share users may be displayed on the display 44. Further, in a case where one second button among the two or more second buttons is selected, a set of share images corresponding to the one second button among the two or more sets of share images, and names of share users who share the set of share images corresponding to the one second button among the two or more share users are displayed on the display 44 in association.

Alternatively, a configuration in which in a case where the public images, the share images, and the private images are respectively disposed side by side at least in a horizontal direction, only a predetermined number of images corresponding to a lateral width of a display area of the display 44 are displayed on the display 44, and remaining images that are not displayed on the display 44 are displayed on the display 44 in a case where the images displayed on the display 44 are scrolled in the horizontal direction may be employed.

Further, in a case where there are two or more sets of share images that are respectively shared with two or more share users, the two or more sets of share images may be classified for each set and may be displayed side by side in a vertical direction on the display 44. Further, the two or more sets of share images and respective names of two or more share users that share the two or more sets of share images may be respectively displayed on the display 44 in association.

In this way, in the image processing system 10, it is possible to clearly display images even in a case where the number of images is large.

Hereinafter, an operation of the image processing system 10 will be specifically described with reference to an example of the client 14 realized with a smartphone and a program operated on the smartphone.

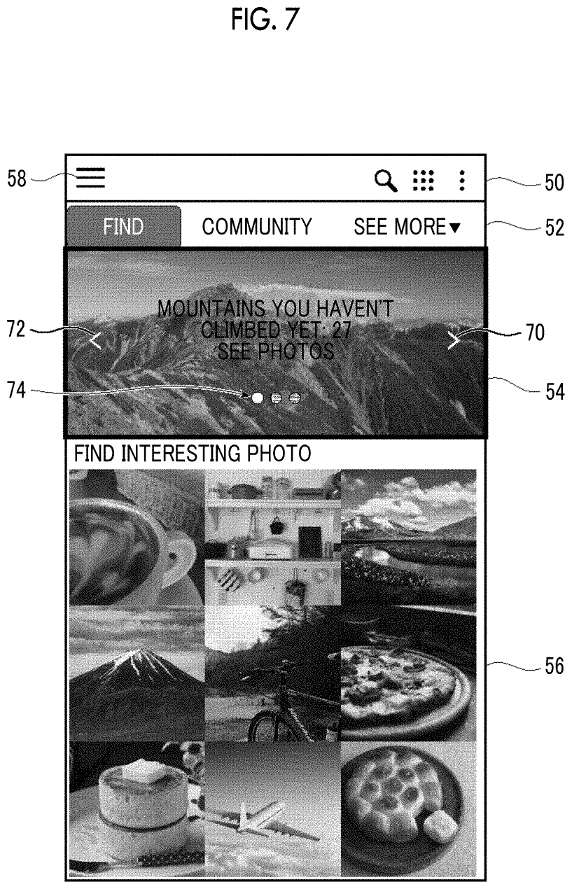

FIG. 7 is a conceptual diagram showing a top level screen displayed by a program operated on a smartphone. A menu bar 50 is displayed in an upper part of the top level screen shown in FIG. 7. A tag bar 52 is displayed under a display area of the menu bar 50, a target 54 is bar-displayed under a display area of a tag bar 52, and thumbnail images 56 are displayed under a display area of the target 54 as a list.

On the top level screen, a menu link button 58 is displayed on a left side in the display area of the menu bar 50. In a case where a first user taps the menu link button 58, a screen of a menu list at the highest level is displayed.

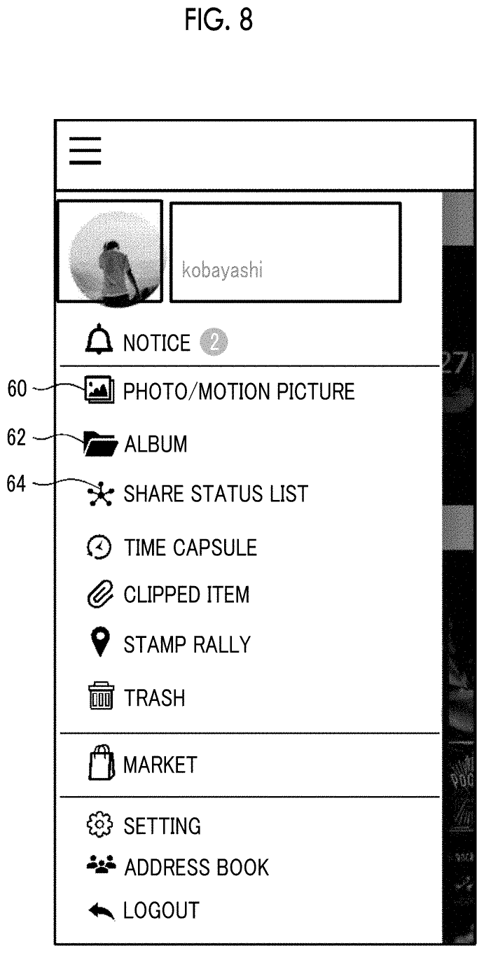

FIG. 8 is a conceptual diagram showing a screen of a menu list of the highest level. On the screen of the menu list of the highest level shown in FIG. 8, menu item buttons such as a button 60 for a photo/motion picture list screen link, a button 62 for an album list screen link, and a button 64 for a share status list screen link are displayed. For example, in a case where the first user taps the button 60 for the photo/motion picture list screen link, a photo/motion picture list display screen is displayed.

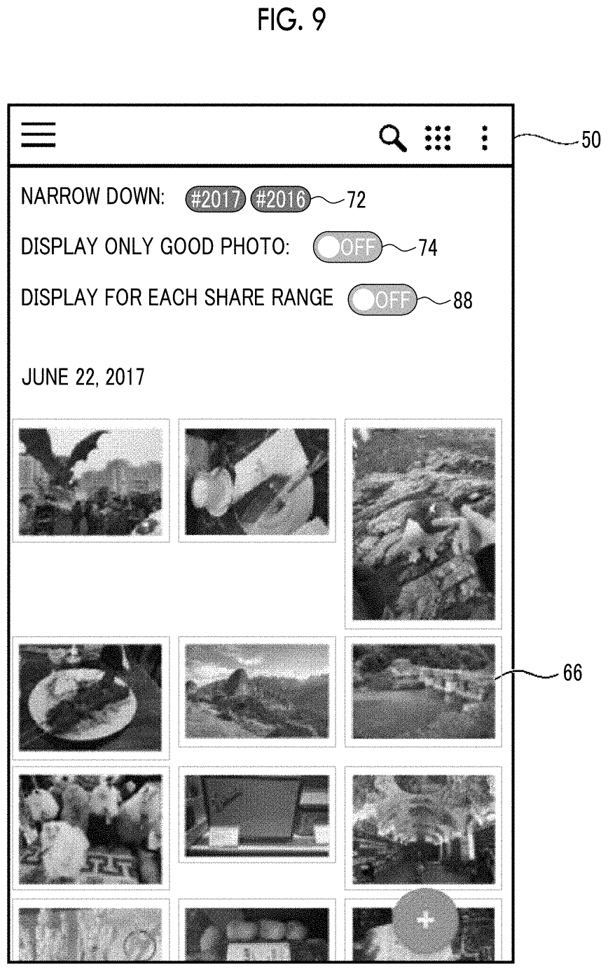

FIG. 9 is a conceptual diagram showing a photo/motion picture list display screen according to the embodiment. On the photo/motion picture list display screen shown in FIG. 9, reduced images (thumbnail images) 66 corresponding to the images included in the image group possessed by the first user are displayed as a list. The thumbnail images 66 are basically grouped in the unit of an imaging date and are displayed in a time series manner. In a case where one thumbnail image is tapped, a detailed display screen (not shown) of an image corresponding to the thumbnail image is displayed.

On the screen of the menu list of the highest level shown in FIG. 8, in a case where the first user taps the button 62 for the album list screen link, an album list display screen is displayed.

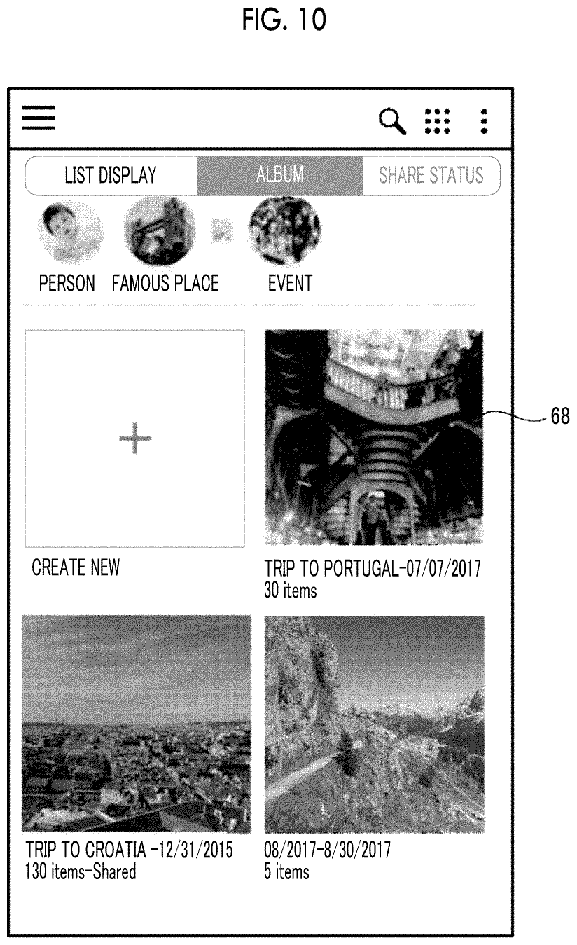

FIG. 10 is a conceptual diagram showing an album list display screen according to the embodiment. On the album list display screen shown in FIG. 10, thumbnail images 68 corresponding to representative images of an album are displayed as a list. With respect to the thumbnail images 68 of the album, pieces of information such as a title of the album, an imaging period of time of images included in the album, the number of images, and the presence or absence of sharing are displayed in association. In a case where one thumbnail image in the album is tapped, a list display screen of images included in the album corresponding to the thumbnail image is displayed.

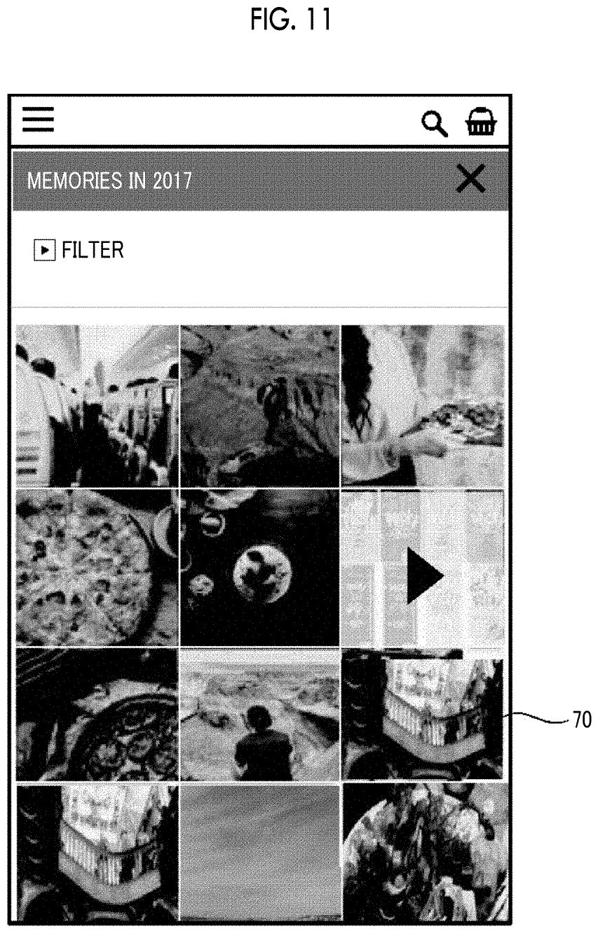

FIG. 11 is a conceptual diagram showing a list display screen of images included in an album according to the embodiment. On the list display screen of the images included in the album shown in FIG. 11, thumbnail images 70 corresponding to the images included in the album are displayed as a list. The thumbnail images 70 are basically grouped in the unit of an imaging date and are displayed in a time series manner. Further, in a case where one thumbnail image is tapped, a detailed display screen (not shown) of an image corresponding to the thumbnail image is displayed.

Next, an operation in a case where images are narrowed down will be described.

On the list display screen of the photo/motion picture shown in FIG. 9, buttons for narrowing down images, such as a “narrow” button 72 and a “display only good photo” button 74, are displayed under the display area of the menu bar 50.

The “narrow” button 72 is used for narrowing down images to which at least one of tag information or Exif information set as a narrowing condition, from the images included in the image group, on the basis of at least one of the tag information or the Exif information assigned to respective images.

In a case where the first user taps the “narrow” button 72, a narrowing condition setting screen (not shown) is displayed. As shown in FIG. 9, for example, in a case where the first user sets keywords of 2017 (#2017) and 2016 (#2016) as the narrowing condition, the images included in the image group are narrowed down to images taken in 2017 and 2016, on the basis of the Exif information assigned to the respective images.

The narrowing condition may be designated as the first user taps one or more buttons of tag information from buttons of tag information that is displayed as a list, for example. Further, the first user may directly input a desired keyword to set the narrowing condition.

The “display only good photo” button 74 is used for narrowing down the images included in the image group to good photo images having a score that is equal to or greater than a threshold set as the narrowing condition, on the basis of scores of the respective images.

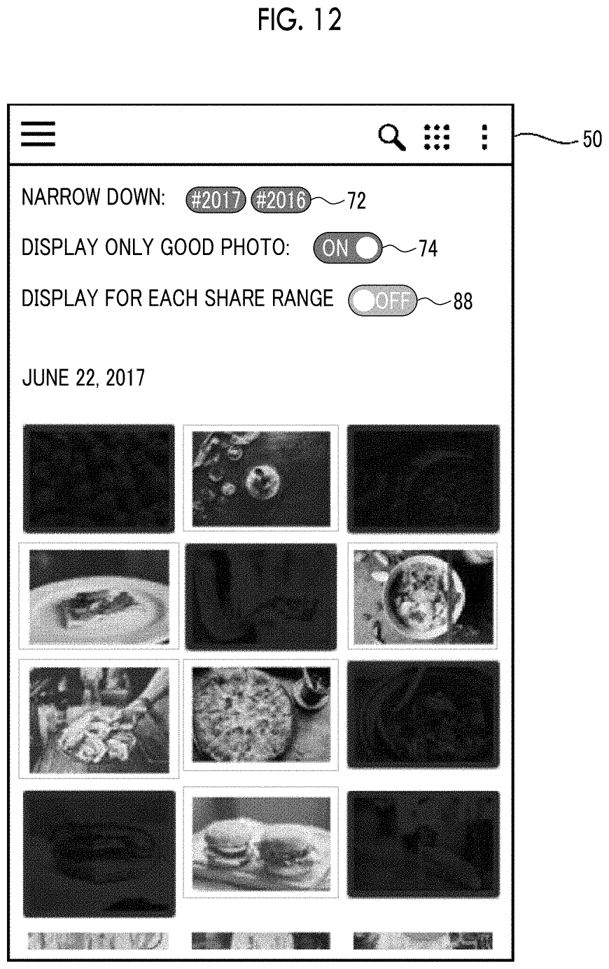

In the case of this embodiment, the threshold value of the scores of the images is set in advance as the narrowing condition, and it is determined that an image having a score that is equal to or greater than the threshold is a good photo image. As shown in FIG. 12, in a case where the first user sets the “display only good photo” button 74 to ON from OFF, the images are narrowed down to images having the score that is equal to or greater than the threshold set as the narrowing condition, and images having a score that is smaller than the threshold value are hidden, so that only images having the score that is equal to or greater than the threshold are displayed as a list.

Next, an operation in a case where images are to be released, shared, and non-released will be described.

The first user may select an image (thumbnail image) on an image selection screen such as the photo/motion picture list display screen shown in FIG. 9 and the list display screen of the images included in the album shown in FIG. 11.

First, the first user selects one thumbnail image from the thumbnail images that are displayed as a list.

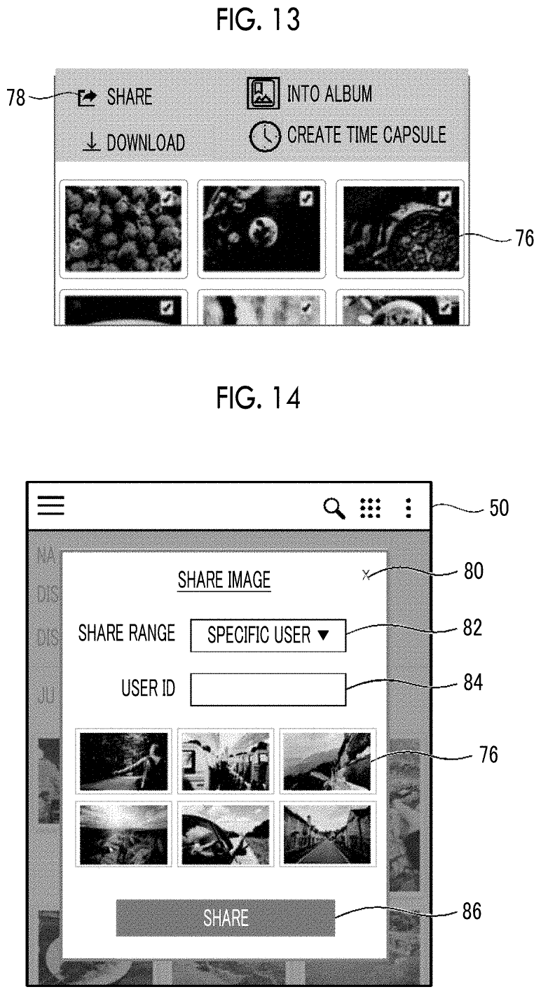

In this case, the first user performs the selection by long-pressing one thumbnail image from thumbnail images 76 that are displayed as a list. As shown in FIG. 13, in a case where one thumbnail image is selected, a check mark in a checkbox on a right part of the selected thumbnail image is displayed. In this state, the first user sequentially taps a second thumbnail and subsequent thumbnail images, to thereby sequentially select the thumbnail images.

In a case where one or more thumbnail images are selected, as shown in FIG. 13, the “share” button 78 or the like is displayed above a selection screen of the thumbnail images 76.

Subsequently, a share range and a share user of an image are set.

In this case, the first user taps the “share” button 78 displayed above the image selection screen. In a case where the “share” button 78 is tapped, a share setting screen is displayed.

FIG. 14 is a conceptual diagram showing a share setting image according to the embodiment. In the case of this embodiment, the share setting screen is displayed in a window format. In an upper part of the share setting screen shown in FIG. 14, a window close button 80 is displayed. Under a display area of the close button 80, an image share range input section 82, an image share user input section 84, a list of the thumbnail images 76 selected on the image selection screen, and a “share” button 86 are displayed.

On the share setting screen, the first user first taps the image share range input section 82. In a case where the image share range input section 82 is tapped, a pull-down menu for list-displaying types of image share ranges is displayed. The first user taps and selects one from “release”, “user designation”, “group designation”, and “non-release” of the pull-down menu as the image share range.

In a case where the first user selects the “user designation” or “group designation” as the image share range, the first user subsequently inputs a user ID of a share user, a name of a group, and the like in the input section 84 of the image share user, to thereby set one or more share users.

Subsequently, “release”, “share”, or “non-release” of an image is set.

In this case, the first user taps the “share” button 86 displayed on the share setting screen. In a case where the “share” button 86 is tapped, images corresponding to the thumbnail images 76 selected on the image selection screen are set to “release”, “share”, or “non-release”.

In a case where “release” is set as the share range, the selected image is released to unspecified users. In a case where “user designation” or “group designation” is set as the share range, the selected image is shared only with the second user or group set as the share users. In a case where “non-release” is set as the share range, the selected image is set to “non-release”. Thus, only the first user can view the image.

On the other hand, in a case where the first user taps the close button 80, the window of the share setting screen is closed to then return to the screen before the share setting screen is displayed.

The first user selects an album on the album list display screen shown in FIG. 10, and then, may similarly set an image included in the album to “release”, “share”, or “non-release”.

Next, an operation in a case where the images included in the image group are classified and displayed for each share range type will be described.

On the photo/motion picture list display screen shown in FIG. 9, a “display for each share range” button 88 is displayed. The “display for each share range” button 88 is used for classifying and displaying the images included in the image group for each share range type.

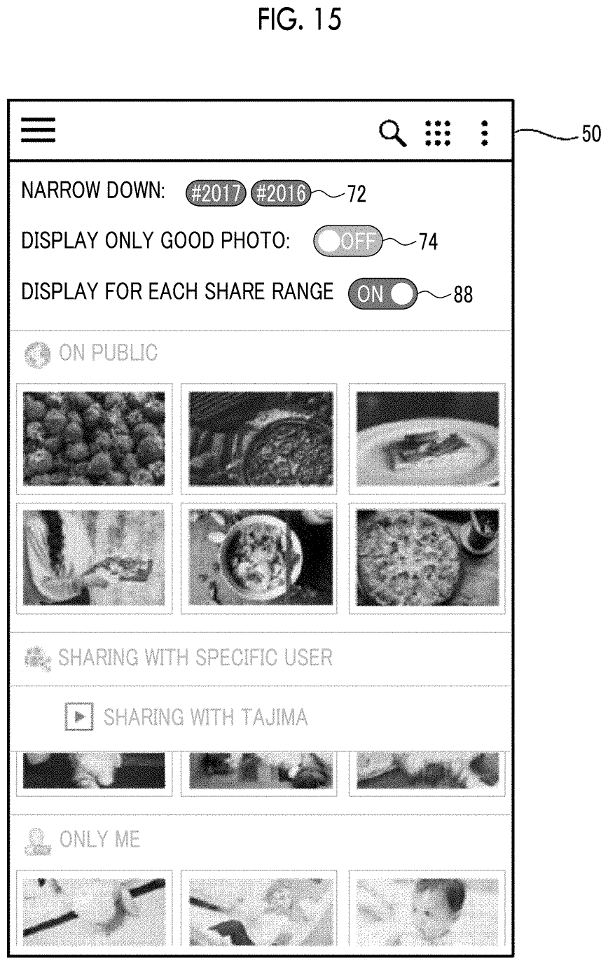

As shown in FIG. 15, in a case where the first user set the “display for each share range” button 88 to ON from OFF, a share status list screen is displayed.

FIG. 15 is a conceptual diagram showing a share status list screen, according to the embodiment. On the share status list screen shown in FIG. 15, the images included in the image group are classified and displayed for each share range type, on the basis of share attribute information read from respective images. Further, “on public” is displayed with respect to a released image, “sharing with specific user” is displayed with respect to a shared image, and “only me” is displayed with respect to a non-released image.

In the related-art image processing system, since a button for displaying a share setting screen is at a very deep level in a hierarchical menu for operating an SNS, it is very difficult to confirm a share image, a share range, and a share user. Further, even in a case where the share image, the share range, and the share user that are mistakenly set are to be modified, it is necessary to follow up a level at a very deep position in the menu, which causes a troublesome situation.

On the other hand, in the image processing system 10, on the menu list screen at the highest level shown in FIG. 8, the button 64 for the link of the share status list screen link is displayed. In this case, the first user taps the menu link button 58 shown in FIG. 7 to display the menu list screen at the highest level, and in a case where the first user taps the button 64 for the share status list screen link on the menu list screen at the highest level, the share status list screen shown in FIG. 15 is displayed.

Accordingly, the first user has only to tap the screen two times to display the share status list screen, and thus, it is possible to rapidly confirm the share image, the share range, and the share user. Further, in a case where the first user modifies the share image, the share range, and the share user, the first user can select an unspecified image through long press on the share status list screen, and can modify the share range and the share user with respect to the selected image.

It is not essential that the image display control apparatus according to the embodiments of the invention is realized using the client 14, and a configuration in which the server 12 includes one or more components among a plurality of components possessed by the client 14 may be employed.

In the apparatus according to the embodiment of the invention, for example, a hardware configuration of processing units that execute various processes, such as the command acquisition unit 18, the image reception unit 20, the share attribute reading unit 22, the image display controller 24, the image analyzer 26, the score calculator 28, the image narrowing unit 30, the image selector 32, the share range setting unit 34, the share user setting unit 36, the image sharing unit 38, the share attribute assigning unit 40, the communication unit 42, and the like, may be dedicated hardware, or may be a variety of processors or a computer that executes a program.

The variety of processors include a central processing unit (CPU) that is a general use processor that functions as a variety of processing units by executing software (program), a programmable logic device (PLD) that is a processor of which a circuit configuration is changeable after manufacturing, such as a field programmable gate array (FPGA), a dedicated electric circuit that is a processor having a circuit configuration that is dedicatedly designed for performing a specific process, such as an application specific integrated circuit (ASIC), or the like.

One processing unit may be configured by one processor among the variety of processors described above, or may be configured by a combination of the same type or different types of two or more processors, for example, a combination of a plurality of FPGAs, a combination of an FPGA and a CPU, or the like. Further, a plurality of processing units may be configured by one processor among a plurality of processors. Furthermore, two or more processing units among a plurality of processing units may be collectively configured by one processor.

For example, as represented by a computer such as a server or a client, a configuration in which a combination of one or more CPUs and software forms one processor and this processor functions as a plurality of processing units may be employed. In addition, as represented by a system on chip (SoC) or the like, a configuration in which a processor for realizing entire functions of a system including a plurality of processing units using one integrated circuit (IC) chip is used may be employed.

Further, the hardware configuration of the variety of processors is, more specifically, electric circuitry in which circuit elements such as semiconductors are combined.

In addition, the method of the embodiment of the invention may be executed by a program for causing a computer to execute the respective steps. Further, a computer-readable recording medium on which the program is recorded may be also provided.

Hereinbefore, the invention has been described in detail, but the invention is not limited to the above-mentioned embodiments, and various modifications or changes may be made in a range without departing from the concept of the invention.

### EXPLANATION OF REFERENCES

10: image processing system

12: server

14: client

16: network

18: command acquisition unit

20: image reception unit

22: share attribute reading unit

24: image display controller

26: image analyzer

28: score calculator

30: image narrowing unit

32: image selector

34: share range setting unit

36: share user setting unit

38: image sharing unit

40: share attribute assigning unit

42: communication unit

44: display

50: menu bar

52: tag bar

54: target

56: thumbnail image

58: menu link button

60: photo/motion picture list screen link button

62: album list screen link button

64: share status list screen link button

66, 68, 70, 76: thumbnail image

72: “narrow” button

74: “display only good photo” button

78: “share” button

80: close button

82: share range input section

84: share user input section

86: “share” button

88: “display for each share range” button

What is claimed is:

1. An image display control apparatus comprising:
an image reception unit that receives an input of an image group possessed by a first user in accordance with a command for designating the image group;
a share attribute reading unit that reads share attribute information that represents share ranges of respective images, assigned to the respective images included in the image group, from the respective images; and
an image display controller that classifies the images included in the image group for each share range type, on the basis of the share attribute information read from the respective images, and displays the classified images on a display.

2. The image display control apparatus according to claim 1,
wherein the share range type includes a public state where an image is released to an unspecified user, a share state where the image is shared only with a share user, and a private state where the image is not released to any user, and
wherein the image display controller classifies and displays the images included in the image group into a public image in the public state, a share image in the share state, and a private image in the private state.

3. The image display control apparatus according to claim 2,
wherein in a case where there are two or more sets of share images that are respectively shared with two or more share users, the image display controller classifies the two or more sets of share images for each set and displays the classified share images.

4. The image display control apparatus according to claim 1,
wherein the share range type includes a public state where an image is released to an unspecified user, a share state where the image is shared only with a share user, and a private state where the image is not released to any user, and
wherein the image display controller displays a first button for displaying a public image in the public state, a second button for displaying a share image in the share state, and a third button for displaying a private image in the private state, and the image display controller displays the public image in a case where the first button is selected, displays the share image in a case where the second button is selected, and displays the private image in a case where the third button is selected.

5. The image display control apparatus according to claim 4,
wherein in a case where there are two or more sets of share images that are respectively shared with two or more share users, the image display controller displays two or more second buttons for respectively displaying the two or more sets of share images.

6. The image display control apparatus according to claim 1,
wherein the share range type includes a public state where an image is released to an unspecified user, a share state where the image is shared only with a share user, and a private state where the image is not released to any user, and
wherein the image display controller respectively disposes public images in the public state, share images in the share state, and private images in the private state side by side at least in a horizontal direction, displays only a predetermined number of images corresponding to a lateral width of a display area of the display, and displays remaining images that are not displayed in a case where the displayed images are scrolled in the horizontal direction.

7. The image display control apparatus according to claim 6, wherein in a case where there are two or more sets of share images that are respectively shared with two or more share users, the image display controller classifies the two or more sets of share images for each set, and disposes the classified share images side by side in a vertical direction for display.

8. The image display control apparatus according to claim 2,
wherein the image display controller displays information indicating that the public image is in the public state, the share image is in the share state, and the private image is in the private state.

9. The image display control apparatus according to claim 8,
wherein the image display controller displays the share image and a name of the share user who shares the share image in association.

10. The image display control apparatus according to claim 2, further comprising:
an image narrowing unit that narrows down the images included in the image group to images that satisfy a narrowing condition in accordance with a command for setting an image narrowing condition,
wherein the image display controller displays only the images narrowed by the image narrowing unit, from among the images included in the image group.

11. The image display control apparatus according to claim 10,
wherein the image narrowing unit narrows down the images included in the image group to images to which at least one of tag information or Exif information set as the narrowing condition is assigned, on the basis of at least one of the tag information or the Exif information assigned to each image.

12. The image display control apparatus according to claim 10, further comprising:
an image analyzer that analyzes the respective images; and
a score calculator that calculates scores of the respective images on the basis of analysis results of the respective images,
wherein the image narrowing unit narrows down the images included in the image group to images having scores that are equal to or greater than a threshold set as the narrowing condition, on the basis of the scores of the respective images calculated by the score calculator.

13. The image display control apparatus according to claim 2, further comprising:
an image selector that selects one image or two or more images from the images included in the image group in accordance with a command for selecting an image;
a share range setting unit that sets share ranges of the one image or two or more images selected by the image selector in accordance with a command for setting the image share range; and
an image sharing unit that sets, in a case where the share range is set to the public state, the share state, or the private state by the share range setting unit, the one image or two or more images selected by the image selector to the public state, to the share state, or to the private state, in accordance with a command for setting an image to the public state, the share state, or the private state; and
a share attribute assigning unit that assigns the share attribute information indicating the public state, the share state, or the private state to the one image or two or more images that are in the public state, the share state, or the private state.

14. The image display control apparatus according to claim 13, further comprising:
a share user setting unit that sets a share user who shares the one image or two or more images selected by the image selector in accordance with a command for setting the share user in a case where the share range is set to the share state by the share range setting unit,
wherein the image sharing unit shares the one image or two or more images selected by the image selector only with the share user set by the share user setting unit in accordance with a command for setting the image to the share state, and
wherein the share attribute assigning unit assigns the share attribute information indicating the share state to the share user set by the share user setting unit to each of the shared one image or two or more images.

15. The image display control apparatus according to claim 2,
wherein one set of share images are shared with two or more share users.

16. The image display control apparatus according to claim 2,
wherein the share user is at least one of a second user or a group of two or more users.

17. The image display control apparatus according to claim 1,
wherein the image display controller displays a menu item button for classifying and displaying the images included in the image group for each share range type on a menu list screen at the highest level.

18. An image display control method of the image display control apparatus according to claim 1 comprising:
a step of receiving the input of the image group possessed by the first user in accordance with the command for designating the image group, using the image reception unit;
a step of reading the share attribute information that represents the share ranges of the respective images, assigned to the respective images included in the image group, from the respective images, using the share attribute reading unit; and
a step of classifying the images included in the image group for each share range type, on the basis of the share attribute information read from the respective images, and displaying the classified images on the display, using the image display controller.

19. The image display control method according to claim 18,
wherein the share range type includes a public state where an image is released to an unspecified user, a share state where the image is shared only with a share user, and a private state where the image is not released to any user, and
wherein the images included in the image group are classified into a public image in the public state, a share image in the share state, and a private image in the private state, and the classified images are displayed.

20. The image display control method according to claim 18,
wherein the share range type includes a public state where an image is released to an unspecified user, a share state where the image is shared only with a share user, and a private state where the image is not released to any user, and
wherein a first button for displaying a public image in the public state, a second button for displaying a share image in the share state, and a third button for displaying a private image in the private state are displayed, and the public image is displayed in a case where the first button is selected, the share image is displayed in a case where the second button is selected, and the private image is displayed in a case where the third button is selected.

21. The image display control method according to claim 18,
wherein the share range type includes a public state where an image is released to an unspecified user, a share state where the image is shared only with a share user, and a private state where the image is not released to any user, and
wherein public images in the public state, share images in the share state, and private images in the private state are respectively disposed side by side at least in a horizontal direction, only a predetermined number of images corresponding to a lateral width of a display area of the display is displayed, and remaining images that are not displayed are displayed in a case where the displayed images are scrolled in the horizontal direction.

22. The image display control method according to claim 20, further comprising:
a step of narrowing down the images included in the image group to images that satisfy a narrowing condition in accordance with a command for setting an image narrowing condition, using an image narrowing unit,
wherein only the narrowed images from among the images included in the image group are displayed.

23. The image display control method according to claim 22, further comprising:
a step of selecting one image or two or more images from the images included in the image group, in accordance with a command for selecting an image, using an image selector;
a step of setting share ranges of the one image or two or more images selected by the image selector, in accordance with a command for setting the image share range, using a share range setting unit; and
a step of setting, in a case where the share range is set to the public state, the share state, or the private state by the share range setting unit, the one image or two or more images selected by the image selector to the public state, to the share state, or to the private state, in accordance with a command for setting an image to the public state, the share state, or the private state, using an image sharing unit; and
a step of assigning the share attribute information indicating the public state, the share state, or the private state to the one image or two or more images that are in the public state, the share state, or the private state, using a share attribute assigning unit.

24. A non-transitory computer-readable recording medium on which a program for causing a computer to execute the respective steps of the image display control method according to claim 18 is recorded.

25. An image display control apparatus comprising:
an image reception unit that receives an input of an image group possessed by a first user in accordance with a command for designating the image group;
a share attribute reading unit that reads share attribute information that represents share ranges of respective images, assigned to the respective images included in the image group, from the respective images; and
an image display controller that classifies the images included in the image group for each share range type, on the basis of the share attribute information read from the respective images, and displays the classified images on a display,
wherein the image reception unit, the share attribute reading unit, and the image display controller are configured by a processor that executes dedicated hardware or a program.

26. The image display control apparatus according to claim 25 further comprising:
an image narrowing unit that narrows down the images included in the image group to images that satisfy a narrowing condition in accordance with a command for setting an image narrowing condition,
wherein the image display controller displays only the images narrowed by the image narrowing unit, from among the images included in the image group, and
wherein the image narrowing unit is configured by the processor that executes the dedicated hardware or the program.

27. The image display control apparatus according to claim 26 further comprising:
an image analyzer that analyzes the respective images; and
a score calculator that calculates scores of the respective images on the basis of analysis results of the respective images,
wherein the image narrowing unit narrows down the images included in the image group to images having scores that are equal to or greater than a threshold set as the narrowing condition, on the basis of the scores of the respective images calculated by the score calculator, and
wherein the image analyzer and the score calculator are configured by the processor that executes the dedicated hardware or the program.

28. The image display control apparatus according to claim 25 further comprising:
an image selector that selects one image or two or more images from the images included in the image group in accordance with a command for selecting an image;
a share range setting unit that sets share ranges of the one image or two or more images selected by the image selector in accordance with a command for setting the image share range; and
an image sharing unit that sets, in a case where the share range is set to the public state, the share state, or the private state by the share range setting unit, the one image or two or more images selected by the image selector to the public state, to the share state, or the private state, in accordance with a command for setting an image to the public state, the share state, or the private state; and a share attribute assigning unit that assigns the share attribute information indicating the public state, the share state, or the private state to the one image or two or more images that are in the public state, the share state, or the private state,
wherein the image selector, the share range setting unit, the image sharing unit, and the share attribute assigning unit are configured by the processor that executes the dedicated hardware or the program.

29. The image display control apparatus according to claim 28 further comprising:
a share user setting unit that sets a share user who shares the one image or two or more images selected by the image selector in accordance with a command for setting the share user in a case where the share range is set to the share state by the share range setting unit,
wherein the image sharing unit shares the one image or two or more images selected by the image selector only with the share user set by the share user setting unit in accordance with a command for setting the image to the share stated, and
wherein the share attribute assigning unit assigns the share attribute information indicating the share state to the share user set by the share user setting unit to each of the shared one image or two or more images, and
wherein the share user setting unit is configured by the processor that executes the dedicated hardware or the program.
